(19) United States
(12) Patent Application Publication
(10) Pub. No.: US 2008/0116823 A1
(43) Pub. Date: May 22, 2008

(54) Current-balancing apparatus for lamps

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/603,075

(22) Filed: Nov. 22, 2006

(51) Int. Cl. H05B 41/16

(52) U.S. Cl. 315/277; 315/279

(57) ABSTRACT

The present invention discloses a current-balancing apparatus for lamps. The current-balancing apparatus includes a first transformer, a second transformer and a third transformer, and every transformer has a primary winding and a secondary winding. The current-balancing apparatus balances the current flowing through every lamp in response to the connection of those transformers and the electromagnetic induction of Runge-Lenz Theorem. The two side windings of the first transformer connect to a power stage via a first lamp and a second lamp respectively. The two side windings of the second transformer connect to the power stage via a third lamp and a fourth lamp respectively. The primary winding of the third transformer connects to the two side windings of the first transformer and the secondary winding of the third transformer connects to the two side windings of the second transformer.

### BACKGROUND OF THE INVENTION

1. Field of the Invention

The present invention relates to a current-balancing apparatus for lamps. In particular, this invention utilizes a linking relationship between a plurality of transformers and a plurality of lamps for balancing the current between the lamps.

2. Description of the Related Art

Due to technological developments and consumer demand, the size of LCD panels has become larger and larger. However, LCD panels with a single lamp cannot satisfy the requirements of illumination. Therefore, two or more lamps are necessary for the LCD panel. In order to increase the brightness of the LCD panel balance, the current flowing through each lamp has to be adjusted in time to make the currents of each lamp equal. However, cold cathode fluorescent lamps (CCFLs) have both high instability and negative resistance, so it is very difficult to maintain the resistance of the CCFL. Therefore, the resistance of each lamp is changed and the current flowing through each lamp is different. Because the currents flowing between the lamps are unequal, it makes the brightness unbalanced. Furthermore, the aging rate of the lamps is also different due to the fact that a larger current damages the lamp quicker.

Please refer to FIG. 1, which shows a schematic diagram of a circuit using a differential ballaster to adjust the current of two lamps of the prior art. The circuit includes a transformer 12 having a first coil 121 and a second coil 122. One end of the first coil 121 is connected with an AC power 10 and a second end is connected with a first lamp 141. A second end of the first lamp 141 is connected with a reference voltage G. One end of the second coil 122 is also connected with the AC power 10 and a second end is connected with a second lamp 142. A second end of the second lamp 142 is connected with the reference voltage G. The AC power 10 utilizes the first coil 121 and the second coil 122 of the transformer 12 to form a differential ballaster for individually providing stable current I1 and I2 to the first lamp 141 and the second lamp 142. Therefore, the current flowing through the first lamp 141 and the second lamp 142 is balanced.

Please refer to FIGS. 1 and 2. FIG. 2 is a schematic diagram of an equivalent magnetic loop of the transformer 12 in the FIG. 1. As shown in FIG. 2, the magnetic core 120 includes two side columns A1 and A2, and two shoulder columns A3 and A4. When the currents I1 and I2 are the same, the current flowing through the first coil 121 and the second coil 122 is also equal. The magnetic force of the first coil 121 produced by the current I1 is the same as the magnetic force of the second coil 121 produced by the current I2. This means the magnetic force of the side column A1 is cancelled out by the magnetic force of the side column A2. Therefore, there is no magnetic flux between the shoulder column A3 and A4. At the same time, the magnetic flux Φ1 and Φ2 in the side column A1 and A2 individually forms a loop via the outside air gap. Because the magnetic resistance of the air gap is very high, the inductance induced by the loop is ignored.

Please refer to FIGS. 1 and 3. FIG. 3 shows a schematic diagram of an equivalent magnetic loop of FIG. 1 connected with lamps. When the current I1 of the first lamp 141 is different from the current I2 of the second lamp 142, the magnetic force of the first coil 121 produced by the current I1 is also different from the magnetic force of the second coil 121 produced by the current I2. This means that the magnetic force of the side column A1 is not equal to the magnetic force of the side column A2. The difference between the side column A1 and side column A2 produces a mass of magnetic flux Φ on the low resistance loop composed by the side column A1, the side column A2, the shoulder column A3 and the shoulder column A4. The magnetic flux Φ slices the first coil 121 and the second coil 122 and reacts and produces an amended voltage ΔV between the ends of the coils. The amended voltage ΔV forces the current I1 of the first lamp 141 and the current I2 of the second lamp 142 to recover and balance.

Please refer to FIG. 4, which shows a circuit block schematic diagram of differential ballaster being used to adjust the current between a plurality of lamps of the prior art. The circuit in FIG. 4 includes a plurality of transformers 12 having a first coil 121 and a second coil 122. One end of the first coils 121 is connected with a reference voltage G and a second end is connected with a first lamp 141. A second end of the first lamp 141 is connected with an AC power 10. One end of the second coils 122 is also connected with the reference voltage G and a second end is connected with a second lamp 142. A second end of the second lamp 142 is connected with the AC power 10. The AC power 10 utilizes the first coil 121 and the second coil 122 of the transformers 12 to form a differential ballaster for individually providing stable current I1 and I2 to the first lamp 141 and the second lamp 142. Therefore, the current flowing through the first lamp 141 and the second lamp 142 is balanced. However, it only works between two lamps and cannot work for other lamps.

Please refer to FIG. 5, which shows a circuit block schematic diagram a differential ballaster being used to adjust the current between lamps of another prior art. As shown in FIG. 5, two lamps are used as an example. The two lamps 31 and 32 are connected in parallel. A high voltage end of the two lamps 31 and 32 is connected with an AC power 10 via a differential ballaster 39. The differential ballaster 39 produces an amended voltage. The amended voltage is proportional to the unbalance between the current of the lamps I31 and I32 and adds together to form a common driving voltage. Therefore, the amended driving voltage adjusts the current of the lamps I31 and I32 to balance the current. Although the circuit ensures that the current of two lamps balances, the circuit includes magnetic cores of specified shape and coil frames. The magnetic cores and the coil frames are not standard products, so it is inconvenient to prepare the raw materials and control the cost of the product.

Please refer to FIG. 6, which shows a circuit block schematic diagram of a differential ballaster being used to adjust the current between a plurality of lamps of another prior art. As shown in FIG. 6, a plurality of differential ballasters T1, T2, T3, T4, T5, T6 and T7 are connected with AC power 10 using a tree type. It utilizes a dividing-layer and a dividing current principle to divide the current into a plurality of lamps L1, L2, L3, L4, L5, L6, L7 and L8 and balances the current between the lamps. The operating principle is the same as is used in FIG. 5.

There is a common shortage on the circuits for adjusting the current of lamps of the prior art. When the circuit is applied to a plurality of lamps, it only works for two lamps and cannot be applied to lamps with an odd quantity.

### SUMMARY OF THE INVENTION

Accordingly, the present invention discloses a current-balancing apparatus for lamps, the current-balancing apparatus includes a first transformer, a second transformer, and a third transformer, and every transformer has a primary winding and a secondary winding. The current-balancing apparatus is used to balance the current flowing through every lamp in response to the connection of those transformers and the electromagnetic induction of Runge-Lenz Theorem.

One embodiment of the current-balancing apparatus of the present invention includes a first transformer having a first primary winding and a first secondary winding, wherein one end of the first primary winding and one end of the first secondary winding connect with a power stage via a first lamp and a second lamp respectively; a second transformer having a second primary winding and a second secondary winding, wherein one end of the second primary winding and one end of the second secondary winding connect with the power stage via a third lamp and a fourth lamp respectively; a third transformer having a third primary winding and a third secondary winding, wherein one end of the third primary winding connects with both other ends of the first primary winding and the first secondary winding of the first transformer, and one end of the third secondary winding connects with both other ends of the second primary winding and the second secondary winding of the second transformer, moreover, both other ends of the third primary winding and the third secondary winding of the third transformer connect with each other.

Another embodiment of the current-balancing apparatus of the present invention includes a first transformer having a first primary winding and a first secondary winding, wherein one end of the first primary winding and one end of the first secondary winding connect with a reference end via a first lamp and a second lamp respectively; a second transformer having a second primary winding and a second secondary winding, wherein one end of the second primary winding and one end of the second secondary winding connect with the reference end via a third lamp and a fourth lamp respectively; a third transformer having a third primary winding and a third secondary winding, wherein one end of the third primary winding connects with both other ends of the first primary winding and the first secondary winding of the first transformer, and one end of the third secondary winding connects with both other ends of the second primary winding and the second secondary winding of the second transformer, moreover, both other ends of the third primary winding and the third secondary winding of the third transformer connect with a power stage.

Moreover, the first transformer, the second transformer and the third transformer form a loop, wherein the third primary winding and the third secondary winding of the third transformer connect to the first transformer and the second transformer respectively.

The present invention utilizes the characteristics of electrical-magnetic reaction of a transformer and the loop to make the current flowing through the windings of the first transformer and the second transformer equal. Thereby, the present invention provides the same working current for each lamp that is connected with the windings of the first transformer and the second transformer.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a circuit using a differential ballaster to adjust the current of two lamps of the prior art;

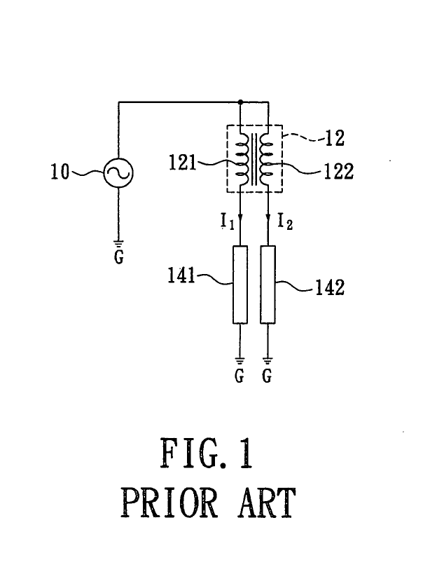

FIG. 2 is a schematic diagram of an equivalent magnetic loop of the transformer in FIG. 1;

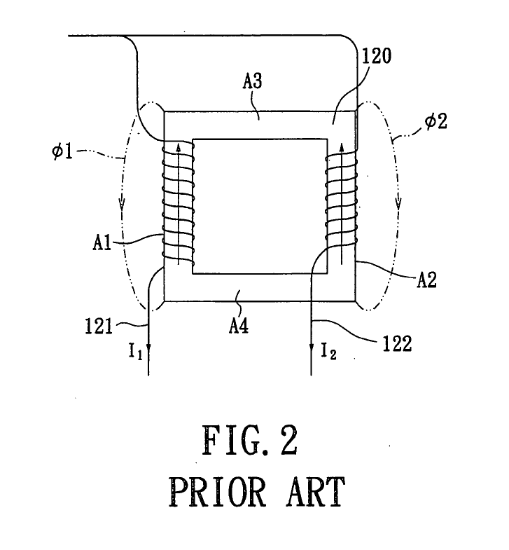

FIG. 3 is a schematic diagram of an equivalent magnetic loop of FIG. 1 connected with lamps;

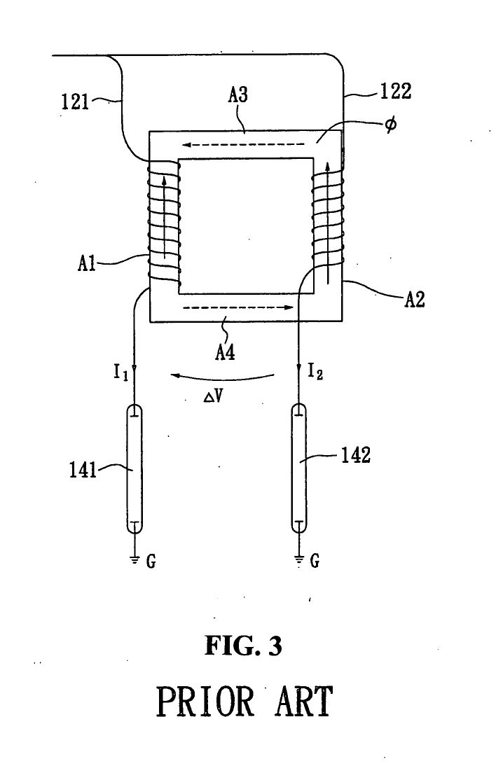

FIG. 4 is a circuit block schematic diagram a differential ballaster being used to adjust the current between a plurality of lamps of the prior art;

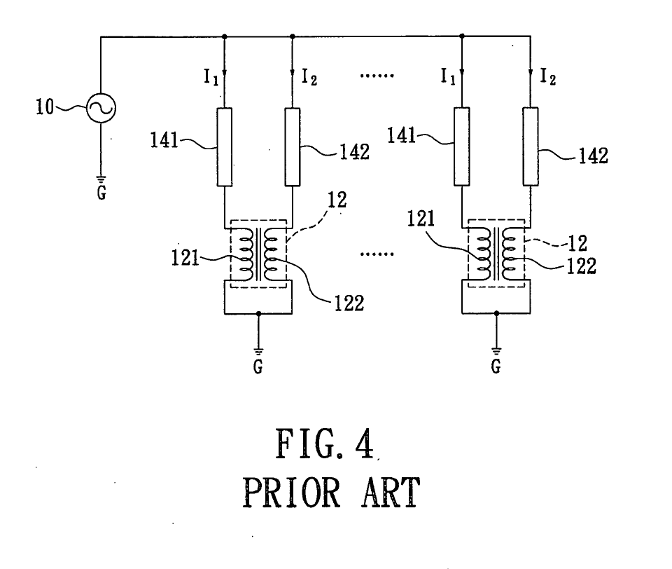

FIG. 5 is a circuit block schematic diagram of a differential ballaster being used to adjust the current between lamps of a second prior art;

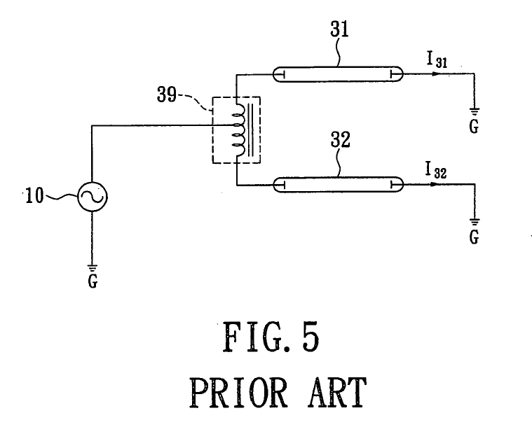

FIG. 6 is a circuit block schematic diagram of a differential ballaster being used to adjust the current between a plurality of lamps of the second prior art;

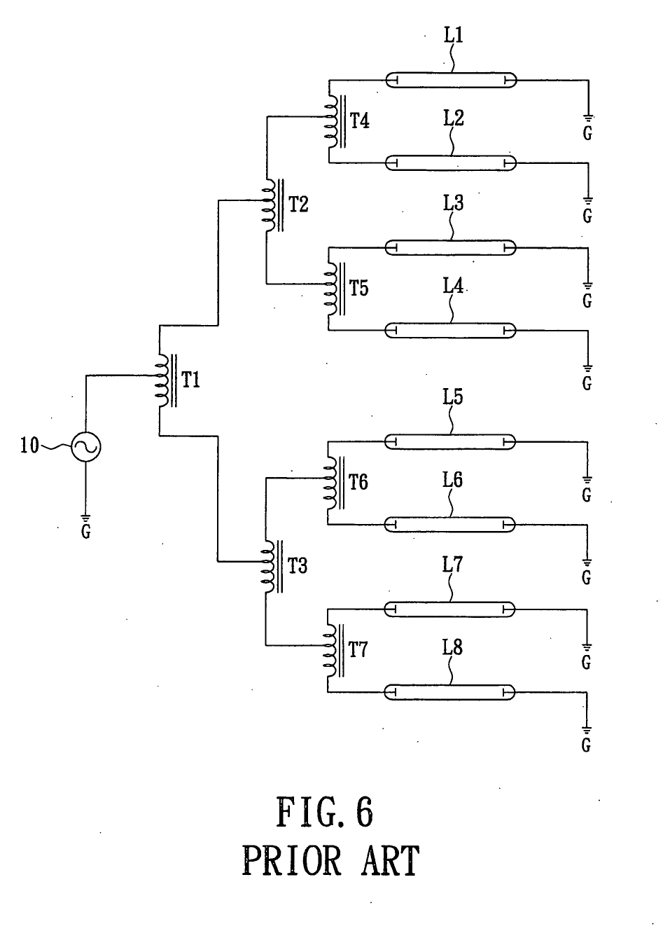

FIG. 7A is a schematic diagram of a current-balancing apparatus for four lamps of the first embodiment of the present invention;

FIG. 7B is a schematic diagram of a current-balancing apparatus for four lamps of the second embodiment of the present invention;

FIG. 8A is a schematic diagram of a current-balancing apparatus for four lamps of the third embodiment of the present invention; and

FIG. 8B is a schematic diagram of a current-balancing apparatus for four lamps of the fourth embodiment of the present invention.

### DETAILED DESCRIPTION OF THE PREFERRED EMBODIMENTS

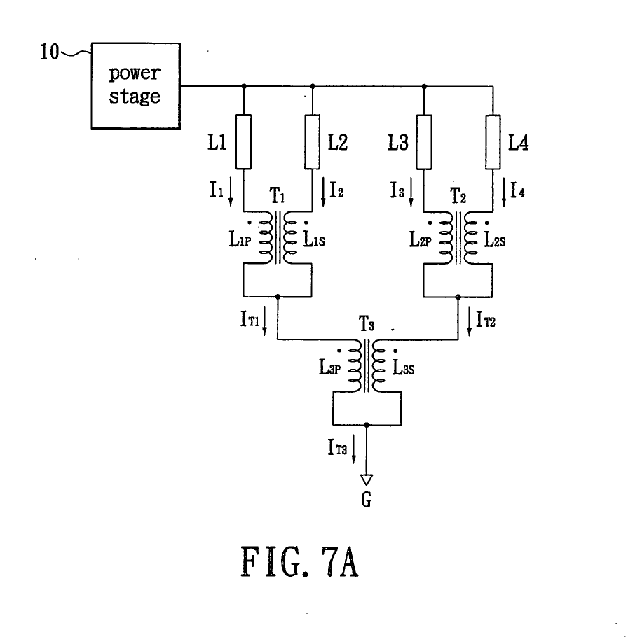

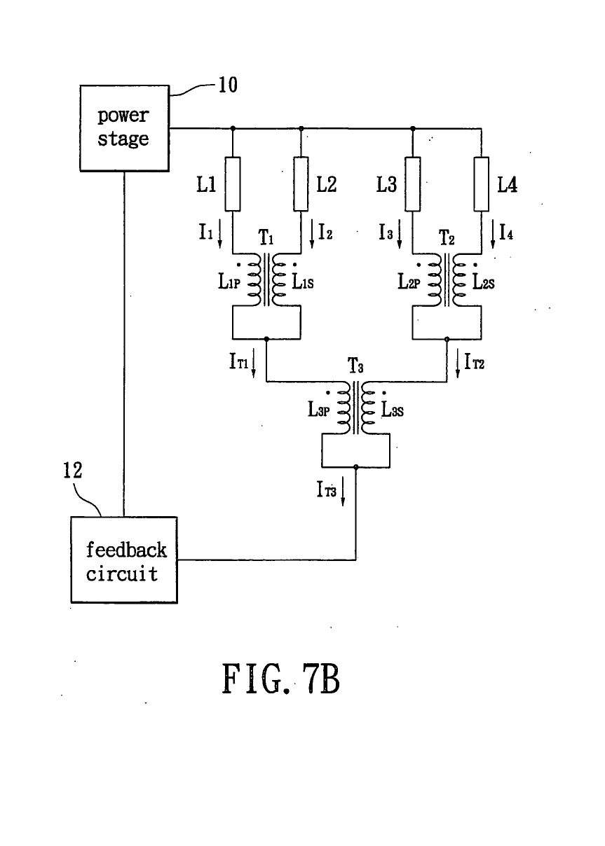

Please refer to FIG. 7A, which shows a schematic diagram of a current-balancing apparatus for four lamps of the first embodiment of the present invention. The apparatus, as shown in FIG. 7A, uses four lamps as an example. The current-balancing apparatus includes a first transformer T1 having a first primary winding L1p and a first secondary winding L1s, a second transformer T2 having a second primary winding L2p and a second secondary winding L2s, and a third transformer T3 having a third primary winding L3p and a third secondary winding L3s.

One end of the first primary winding L1p and one end of the first secondary winding L1s connect with a power stage 10 via a first lamp L1 and a second lamp L2 respectively, moreover, one end of the second primary winding L2p and one end of the second secondary winding L2s connect with the power stage 10 via a third lamp L3 and a fourth lamp L4 respectively. Thereby, the power stage 10 is used to supply an AC power for those lamps L1-L4.

Furthermore, both other ends of the first primary winding L1p and the first secondary winding L1s of the first transformer T1 have the same polar pole and connect with one end of the third primary winding L3p of the third transformer T3. Moreover, both other ends of the second primary winding L2p and the second secondary winding L2s of the second transformer T2 have the same polar pole and connect with one end of the third secondary winding L3s of the third transformer T3. Both other ends of the third primary winding L3p and the third secondary winding L3s of the third transformer T3 connect with a reference end G or the power stage 10 via a feedback circuit 12 (shown in FIG. 7B). Whereby, the power stage 10 is used to provide the same working current I1-I4 for those lamps L1-L4.

Please refer to FIG. 7A again, showing the windings of the first transformer T1, the second transformer T2, and the third transformer T3 having the same number of turns and inductance. Furthermore, the lamps L1-L4 are Cold Cathode Fluorescent Lamps (CCFLs) or External Electrode Fluorescent Lamps (EEFLs).

Please refer to FIG. 7A again. According to the electromagnetic induction of Runge-Lenz Theorem, the working current I1 flows through the first primary winding L1p of the first transformer T1 so as to generate a magnetic field on the first primary winding L1p and one back emf on the first secondary winding L1s. The one back emf on the first secondary winding L1s resists the working current I2 flowing through the first secondary winding L1s.

Moreover, the working current I2 similarly flows through the first secondary winding L1s of the first transformer T1 for generating another magnetic field on the first secondary winding L1s and another back emf on the first primary winding L1p. The other back emf on the first primary winding L1p resists the working current I1 flowing through the first primary winding L1p.

Therefore, the working current I3 and the working current I4 flow through the second primary winding L2p and the second secondary winding L2s of the second transformer T2 respectively, and make the magnetic field built on the second primary winding L2p and the second secondary winding L2s resist each other in order to achieve magnetic balance. Therefore, when the magnetic fields built on both sides of the second transformer T2 are equal, the working current I3 and the working current I4 are equal.

Please refer to FIG. 7A again. From the common ends of the second ends of the first primary winding L1p and the first secondary winding L1s a working current IT1 flows into one end of the third primary winding L3p of the third transformer T3. Moreover, from the common ends of the second ends of the second primary winding L2p and the second secondary winding L2s a working current IT2 flows into one end of the third secondary winding L3s of the third transformer T3.

According to the electromagnetic induction of Runge-Lenz Theorem, the working current IT1 flows through third primary winding L3p of the third transformer T3 to generate a magnetic field on the third primary winding L3p and one back emf on third secondary winding L3s of the third transformer T3. The one back emf on the third secondary winding L3s resists the working current IT2 flowing through the third secondary winding L3s.

Moreover, the working current IT2 flows through the third secondary winding L3s of the third transformer T3 similarly generating another magnetic field on the third secondary winding L3s and another back emf on the third primary winding L3p. The other back emf on the third primary winding L3p resists the working current IT1 flowing through the third primary winding L3p.

Therefore, the working current IT1 and the working current IT2 flow through the third primary winding L3p and the third secondary winding L3s of the third transformer T3 respectively, and make the magnetic field built on the third primary winding L3p and the third secondary winding L3s resist each other for achieving magnetic balance. So, when the magnetic fields built on two sides of the third transformer T3 are equal, as well as, the working current IT1 and the working current IT2 are equal.

According to the description the above, when the working current IT1 and the working current IT2 are equal, the working current I1-I4 flowing through the lamps L1-L4 respectively are equal. Furthermore, the current-balancing apparatus of the present invention can be applied to the resonant circuit of secondary side of a transformer and the lamps with an even quantity.

Please refer to FIG. 7A again. From the common end of the other ends of the third primary winding L3p and the third secondary winding L3s flows a working current IT3 into the reference end G of the power stage 10, or the working current IT3 flows into the power stage 10 via a feedback circuit 12 for being the second embodiment of the present invention (refer to FIG. 7A).

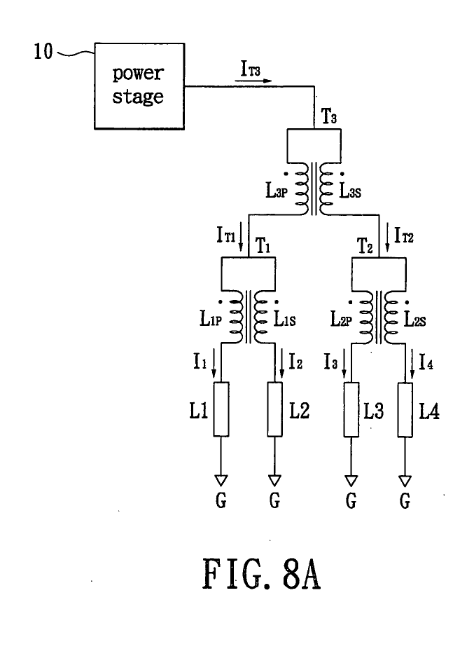

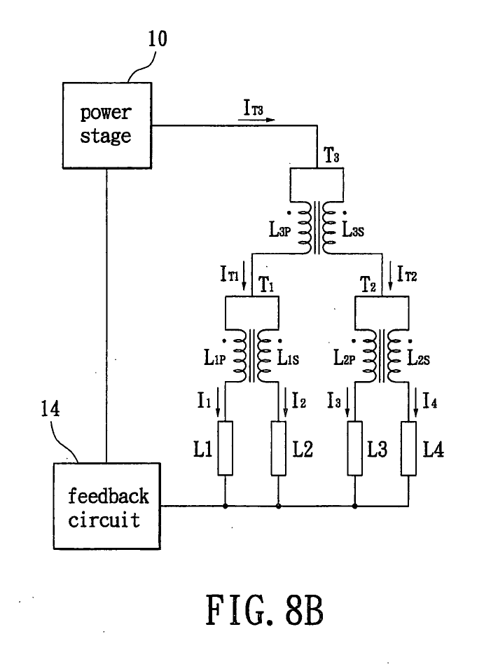

Please refer to FIG. 8A, which shows a schematic diagram of a current-balancing apparatus for four lamps of the third embodiment of the present invention. The apparatus, as shown in FIG. 8A, uses four lamps as an example. The current-balancing apparatus includes a first transformer T1 having a first primary winding L1p and a first secondary winding L1s, a second transformer T2 having a second primary winding L2p and a second secondary winding L2s, and a third transformer T3 having a third primary winding L3p and a third secondary winding L3s.

One end of the first primary winding L1p and one end of the first secondary winding L1s connect with a reference end G via a first lamp L1 and a second lamp L2 respectively, or, connect with a power stage 10 via a feedback circuit 14 (please refer to FIG. 8B). Moreover, one end of the second primary winding L2p and one end of the second secondary winding L2s connect with the reference end G via a first lamp L3 and a second lamp L4 respectively, or, connect with the power stage 10 via the feedback circuit 14 (refer to FIG. 8B). Thereby, the power stage 10 is used to supply an AC power for those lamps L1-L4 (refer to FIG. 8B).

Furthermore, both other ends of the first primary winding L1p and the first secondary winding L1s of the first transformer T1 have the same polar pole and connect with one end of the third primary winding L3p of the third transformer T3. Moreover, both other ends of the second primary winding L2p and the second secondary winding L2s of the second transformer T2 have the same polar pole and connect with one end of the third secondary winding L3s of the third transformer T3. Both other ends of the third primary winding L3p and the third secondary winding L3s of the third transformer T3 connect with the power stage 10. Whereby, the power stage 10 is used to supply an AC power to the third transformer T3 for providing the same working current I1-I4 for those lamps L1-L4.

Please refer to FIG. 8A again. The windings of the first transformer T1, the second transformer T2 and the third transformer T3 have the same number of turns and inductance. Furthermore, those lamps L1-L4 are Cold Cathode Fluorescent Lamps (CCFLS) or External Electrode Fluorescent Lamps (EEFLs).

Please refer to FIGS. 7A and 8A. The operation principle and formulas of the circuit of the FIG. 8A are the same as those of the circuit of the FIG. 7A, so any redundancies have been omitted from the following.

According to the electromagnetic induction of Runge-Lenz Theorem, the working current I1 and the working current I2 flow through the first primary winding L1p and the first secondary winding L1s of the first transformer T1 respectively, and make the magnetic fields built on the first primary winding L1p and the first secondary winding L1s resist each other in order to be balanced and equal. Moreover, the working current I3 and the working current I4 flow through the second primary winding L2p and the second secondary winding L2s of the second transformer T2 respectively, and make the magnetic field built on the second primary winding L2p and the second secondary winding L2s resist each other in order to be balanced and equal.

According to the electromagnetic induction of Runge-Lenz Theorem, the working current IT1 and the working current IT2 flow through the third primary winding L3p and the third secondary winding L3s of the third transformer T3 respectively, and make the magnetic field built on the third primary winding L3p and the third secondary winding L3s resist each other in order to be balanced and equal.

According to the description above, when the working current IT1 and the working current IT2 are equal, the working current I1-I4 flowing through the lamps L1-L4 respectively are equal. Furthermore, the current-balancing apparatus of the present invention can be applied to the resonant circuit of secondary side of a transformer and the lamps evenly.

Please refer to FIG. 8A again. The power stage 10 supplies the working current IT3 to the third transformer T3. Moreover, the working current I1-I4 flowing through the lamps L1-L4 flows into the reference end G of the power stage 10, or flows into the power stage 10 via a feedback circuit 14 for being the fourth embodiment of the present invention (refer to FIG. 8B).

To sum up, the present invention discloses a current-balancing apparatus for lamps, the current-balancing apparatus includes a first transformer, a second transformer, and a third transformer, and every transformer has a primary winding and a secondary winding. The current-balancing apparatus balances the current flowing through every lamp in response to the connection of those transformers and the electromagnetic induction of Runge-Lenz Theorem. Therefore, the present invention improves upon the flaws in the traditional current-balancing circuit that only support two lamps to balance current. Moreover, the present invention uses fewer elements than the traditional current-balancing circuit for achieving the current-balancing for lamps.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A current-balancing apparatus for lamps, comprising:
a first transformer, having a first primary winding and a first secondary winding, wherein one end of the first primary winding and one end of the first secondary winding are connected with a power stage via a first lamp and a second lamp respectively;
a second transformer, having a second primary winding and a second secondary winding, wherein one end of the second primary winding and one end of the second secondary winding are connected with the power stage via a third lamp and a fourth lamp respectively;
a third transformer, having a third primary winding and a third secondary winding, wherein one end of the third primary winding is connected with both other ends of the first primary winding and the first secondary winding of the first transformer, and one end of the third secondary winding is connected with both other ends of the second primary winding and the second secondary winding of the second transformer, moreover, both other ends of the third primary winding and the third secondary winding of the third transformer are connected with each other.

2. The current-balancing apparatus for lamps as claimed in claim 1, wherein both other ends of the third primary winding and the third secondary winding of the third transformer are connected with a reference end or the power stage via a feedback circuit.

3. The current-balancing apparatus for lamps as claimed in claim 1, wherein the windings of the first transformer, the second transformer, and the third transformer have the same number of turns.

4. The current-balancing apparatus for lamps as claimed in claim 1, wherein the lamps are CCFLs or EEFLs.

5. The current-balancing apparatus for lamps as claimed in claim 1, wherein the power stage supplies an AC power to the lamps.

6. The current-balancing apparatus for lamps as claimed in claim 1, wherein the first primary winding and the first secondary winding of the first transformer are connected with the third transformer by the same polar ends, moreover, the second primary winding and the second secondary winding of the second transformer are connected with the third transformer by the same polar ends.

7. A current-balancing apparatus for lamps, comprising:
a first transformer, having a first primary winding and a first secondary winding, wherein one end of the first primary winding and one end of the first secondary winding are connected with a reference end via a first lamp and a second lamp respectively;
a second transformer, having a second primary winding and a second secondary winding, wherein one end of the second primary winding and one end of the second secondary winding are connected with the reference end via a third lamp and a fourth lamp respectively;
a third transformer, having a third primary winding and a third secondary winding, wherein one end of the third primary winding is connected with both other ends of the first primary winding and the first secondary winding of the first transformer, and one end of the third secondary winding is connected with both other ends of the second primary winding and the second secondary winding of the second transformer, moreover, both other ends of the third primary winding and the third secondary winding of the third transformer are connected with the power stage.

8. The current-balancing apparatus for lamps as claimed in claim 7, wherein the lamps are connected with the power stage via a feedback circuit.

9. The current-balancing apparatus for lamps as claimed in claim 7, wherein the windings of the first transformer, the second transformer and the third transformer have the same number of turns.

10. The current-balancing apparatus for lamps as claimed in claim 7, wherein the lamps are CCFLs or EEFLs.

11. The current-balancing apparatus for lamps as claimed in claim 7, wherein the power stage supplies an AC power to the third transformer.

12. The current-balancing apparatus for lamps as claimed in claim 7, wherein the first primary winding and the first secondary winding of the first transformer are connected with the third transformer by the same polar ends, moreover, the second primary winding and the second secondary winding of the second transformer are connected with the third transformer by the same polar ends.
